(19) United States
(12) Patent Application Publication
(10) Pub. No.: US 2025/0351084 A1
(43) Pub. Date: Nov. 13, 2025

(54) DISCONTINUOUS RECEPTION (DRX) WITH NON-UNIFORM CYCLES

(71) Applicant: QUALCOMM Incorporated, San Diego, CA (US)

(72) Inventor: Linhai HE, San Diego, CA (US)

(21) Appl. No.: 19/200,448

(22) Filed: May 6, 2025

Related U.S. Application Data
(60) Provisional application No. 63/644,272, filed on May 8, 2024.

(51) Int. Cl. H04W 52/02; H04W 72/231; H04W 76/28

(52) U.S. Cl. CPC H04W 52/0235; H04W 52/0216; H04W 72/231; H04W 76/28

(57) ABSTRACT

Methods, systems, and devices for wireless communications are described. In some wireless communications systems, a user equipment (UE) may support discontinuous reception (DRX) operation. The UE may receive, from a network entity, configuration signaling indicating multiple DRX cycles (e.g., multiple long DRX cycles, multiple short DRX cycles, or both). For example, different DRX cycles may correspond to receiving different types of traffic according to different periodicities. In some examples, a type of traffic may correspond to a specific DRX cycle (e.g., long DRX cycle) or a pair of specific DRX cycles (e.g., short and long DRX cycles). The UE may calculate start times for an on duration timer for the DRX operation based on multiple DRX cycles. The UE may start the on duration timer at the start times and may monitor a control channel while the on duration timer is running.

The present Application for Patent claims the benefit of U.S. Provisional Patent Application No. 63/644,272 by Linhai He, entitled “DISCONTINUOUS RECEPTION (DRX) WITH NON-UNIFORM CYCLES,” filed May 8, 2024, assigned to the assignee hereof, and expressly incorporated by reference herein.

### FIELD OF TECHNOLOGY

### Field of Technology

The following relates to wireless communications, including discontinuous reception (DRX) operation.

### Background

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A user equipment (UE) for wireless communications is described. The UE may include one or more memories storing processor executable code, and one or more processors coupled with the one or more memories. The one or more processors may individually or collectively be operable to execute the code to cause the UE to receive configuration signaling that indicates a first value for a first discontinuous reception (DRX) cycle and a second value for a second DRX cycle, start an on duration timer for DRX operation based on a set of multiple start times including both a first set of start times associated with the first value for the first DRX cycle and a second set of start times associated with the second value for the second DRX cycle, and monitor a physical downlink control channel (PDCCH) based on an active time for the UE, where the active time includes a time period when the on duration timer is running.

A method for wireless communications at a UE is described. The method may include receiving configuration signaling that indicates a first value for a first DRX cycle and a second value for a second DRX cycle, starting an on duration timer for DRX operation based on a set of multiple start times including both a first set of start times associated with the first value for the first DRX cycle and a second set of start times associated with the second value for the second DRX cycle, and monitoring a PDCCH based on an active time for the UE, where the active time includes a time period when the on duration timer is running.

Another UE for wireless communications is described. The UE may include means for receiving configuration signaling that indicates a first value for a first DRX cycle and a second value for a second DRX cycle, means for starting an on duration timer for DRX operation based on a set of multiple start times including both a first set of start times associated with the first value for the first DRX cycle and a second set of start times associated with the second value for the second DRX cycle, and means for monitoring a PDCCH based on an active time for the UE, where the active time includes a time period when the on duration timer is running.

A non-transitory computer-readable medium storing code at a UE for wireless communications is described. The code may include instructions executable by one or more processors to receive configuration signaling that indicates a first value for a first DRX cycle and a second value for a second DRX cycle, start an on duration timer for DRX operation based on a set of multiple start times including both a first set of start times associated with the first value for the first DRX cycle and a second set of start times associated with the second value for the second DRX cycle, and monitor a PDCCH based on an active time for the UE, where the active time includes a time period when the on duration timer is running.

Some examples of the method, UEs, and non-transitory computer-readable medium described herein may further include operations, features, means, or instructions for calculating the set of multiple start times based on a first periodicity corresponding to the first value for the first DRX cycle and a second periodicity corresponding to the second value for the second DRX cycle.

In some examples of the method, UEs, and non-transitory computer-readable medium described herein, the first DRX cycle includes a first long DRX cycle, the second DRX cycle includes a second long DRX cycle, and the set of multiple start times includes a first set of multiple start times associated with a long DRX cycle. In some such examples of the method, UEs, and non-transitory computer-readable medium described herein, the configuration signaling further indicates a third value for a first short DRX cycle, a fourth value for a second short DRX cycle, or both.

Some examples of the method, UEs, and non-transitory computer-readable medium described herein may further include operations, features, means, or instructions for starting a short cycle timer for the DRX operation and starting the on duration timer based on a second set of multiple start times associated with the third value for the first short DRX cycle, the fourth value for the second short DRX cycle, or both in accordance with the short cycle timer running, where the on duration timer may be started based on the first set of multiple start times associated with the long DRX cycle in accordance with an expiration of the short cycle timer.

Some examples of the method, UEs, and non-transitory computer-readable medium described herein may further include operations, features, means, or instructions for starting an inactivity timer for the DRX operation, where the short cycle timer may be started or restarted in accordance with an expiration of the inactivity timer.

In some examples of the method, UEs, and non-transitory computer-readable medium described herein, the first long DRX cycle and the first short DRX cycle correspond to a first type of traffic and the second long DRX cycle and the second short DRX cycle correspond to a second type of traffic different from the first type of traffic.

In some examples of the method, UEs, and non-transitory computer-readable medium described herein, the first DRX cycle corresponds to a first type of traffic and the second DRX cycle corresponds to a second type of traffic different from the first type of traffic.

Some examples of the method, UEs, and non-transitory computer-readable medium described herein may further include operations, features, means, or instructions for refraining from starting or restarting the on duration timer based on a start time of the set of multiple start times occurring when the on duration timer is running.

Some examples of the method, UEs, and non-transitory computer-readable medium described herein may further include operations, features, means, or instructions for restarting the on duration timer based on a start time of the set of multiple start times occurring when the on duration timer is running.

Some examples of the method, UEs, and non-transitory computer-readable medium described herein may further include operations, features, means, or instructions for maintaining the on duration timer, an inactivity timer, and a short cycle timer for a medium access control (MAC) entity.

In some examples of the method, UEs, and non-transitory computer-readable medium described herein, the first value, the second value, or both may be integer values, non-integer values, or a combination thereof.

In some examples of the method, UEs, and non-transitory computer-readable medium described herein, the on duration timer may be a drx-onDurationTimer.

In some examples of the method, UEs, and non-transitory computer-readable medium described herein, the configuration signaling includes a radio resource control (RRC) message.

Details of one or more implementations of the subject matter described in this disclosure are set forth in the accompanying drawings and the description below. Other features and aspects will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support discontinuous reception (DRX) with non-uniform cycles in accordance with one or more aspects of the present disclosure.

FIGS. 3A and 3B show examples of timelines that support DRX with non-uniform cycles in accordance with one or more aspects of the present disclosure.

FIG. 4 shows an example of a process flow that supports DRX with non-uniform cycles in accordance with one or more aspects of the present disclosure.

FIGS. 5 and 6 show block diagrams of devices that support DRX with non-uniform cycles in accordance with one or more aspects of the present disclosure.

FIG. 7 shows a block diagram of a communications manager that supports DRX with non-uniform cycles in accordance with one or more aspects of the present disclosure.

FIG. 8 shows a diagram of a system including a device that supports DRX with non-uniform cycles in accordance with one or more aspects of the present disclosure.

FIGS. 9 and 10 show flowcharts illustrating methods that support DRX with non-uniform cycles in accordance with one or more aspects of the present disclosure.

### DETAILED DESCRIPTION

In some wireless communications systems, a user equipment (UE) may operate according to a discontinuous reception (DRX) mode. In the DRX mode, the UE may conserve battery life by reducing power consumption (e.g., operating according to a low power mode) and periodically waking up (e.g., entering a high, or normal, power mode) to monitor for communications. A network entity may configure the UE with a DRX cycle defining a periodicity for the UE to wake up and monitor a control channel for communications. In some cases, the network may configure the UE with both a short DRX cycle and a long DRX cycle, where the short DRX cycle corresponds to a relatively shorter periodicity than the long DRX cycle. The UE may operate according to either the short DRX cycle or the long DRX cycle (e.g., based on a short cycle timer). However, in some wireless communications systems, the network and UE may communicate multiple different types of traffic (e.g., video data, audio data, voice data, control information, positional updates, haptic data, or any other types of wireless communication traffic) concurrently, for example, to support an application. In some cases, different types of traffic may correspond to different communication periodicities. If these different communication periodicities are not integer multiples of each other (e.g., correspond to non-uniform cycles), a single DRX cycle may fail to concurrently support the different communication periodicities.

As described herein, a UE may concurrently operate according to multiple DRX cycles to provide support for multiple types of traffic with different (e.g., non-uniform, non-overlapping) periodicities. A network entity may configure the UE with multiple DRX cycles of a same type (e.g., multiple long DRX cycles, multiple short DRX cycles, or both). For example, the network entity may transmit, to the UE, configuration signaling indicating at least a first value (e.g., defining a first periodicity) for a first long DRX cycle and a second value (e.g., defining a second, different periodicity) for a second long DRX cycle. The first long DRX cycle may support a first traffic periodicity for a first type of traffic and the second long DRX cycle may support a second traffic periodicity for a second type of traffic. The UE may determine (e.g., calculate, select, or otherwise identify) a set of start times for an on duration timer for DRX operation based on both the first value for the first long DRX cycle and the second value for the second long DRX cycle. For example, the set of start times may include start times in accordance with both the first periodicity and the second periodicity. Accordingly, the set of start times may support waking the UE up to monitor for communications for the first type of traffic and communications for the second type of traffic, despite the communications for the first type of traffic and the communications for the second type of traffic occurring at periodicities that do not align in time. The UE may start an on duration timer according to the determined set of start times and may monitor a control channel while the on duration timer is running.

The UE may improve communication reliability by operating according to multiple DRX cycles concurrently. For example, the UE may wake up and monitor for multiple different types of traffic based on the set of start times associated with different periodicities for the different types of traffic. Accordingly, the UE may robustly support applications, such as extended reality (XR) or other applications, that generate different types of traffic with different traffic flows. Additionally, or alternatively, the UE may improve battery life and conserve power by supporting the DRX mode—and corresponding low power states for battery conservation—with the multiple types of traffic.

In some examples, the UE may maintain a single on duration timer, a single inactivity timer, and a single short cycle timer for a medium access control (MAC) entity. The UE may improve a processing overhead associated with timer management by efficiently using the same timers for multiple DRX cycles. Additionally, or alternatively, the UE may reduce processing resources associated with tracking DRX cycle operation by operating according to short DRX cycles for each type of traffic or according to long DRX cycles for each type of traffic, rather than separately determining whether to use a short or long cycle for a specific type of traffic. The UE may support a single long DRX cycle, multiple long DRX cycles, a single short DRX cycle, multiple short DRX cycles, or any combination thereof for DRX operation.

Aspects of the disclosure are initially described in the context of wireless communications systems. Additional aspects of the disclosure are described with reference to timelines and process flows associated with DRX operations. Aspects of the disclosure are further illustrated by and described with reference to apparatus diagrams, system diagrams, and flowcharts that relate to DRX with non-uniform cycles.

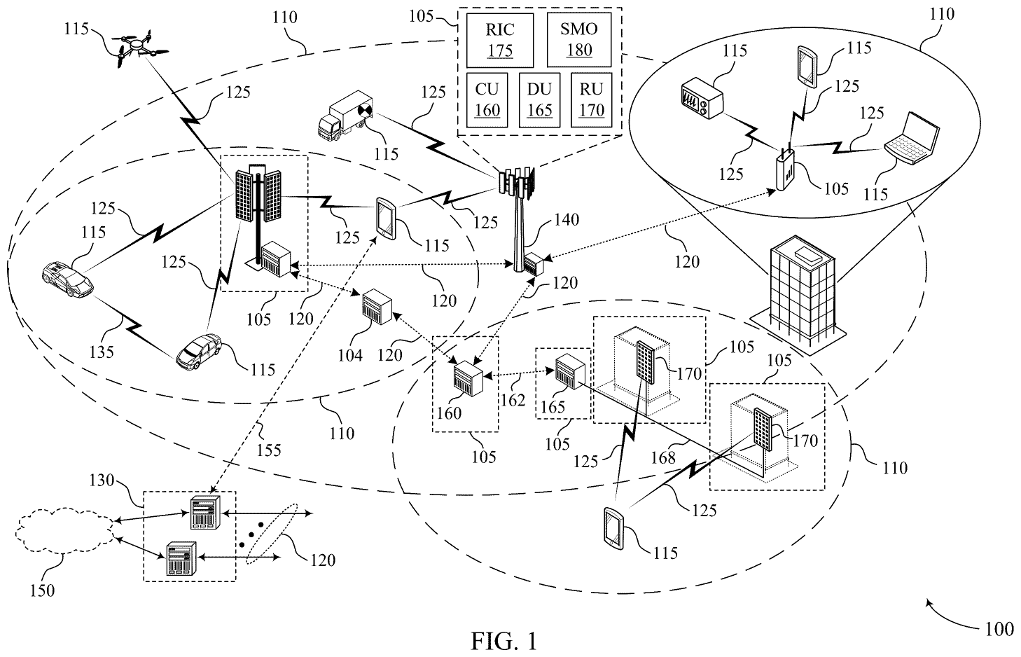

FIG. 1 shows an example of a wireless communications system 100 that supports DRX with non-uniform cycles in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support DRX operations. For example, a network entity 105 may configure the UE 115 with a DRX configuration. In some cases, the network (e.g., the network entity 105) may configure one DRX configuration for NR operation. In some other cases, the network and UE 115 may support dual DRX configuration. For dual DRX configuration, the network may configure the UE 115 with one DRX configuration per frequency range (FR), including FR1 and FR2. Such dual DRX configurations may use independent DRX inactivity timers but may have the same DRX cycle (e.g., the same periodicity for waking up from a sleep, or low power, state).

Some applications may use different types of traffic with different traffic flows. For example, XR applications may generate different types of traffic flows (e.g., the XR application traffic may be multi-modal). Examples of the different types of traffic may include video data, audio data, voice data, control information, positional updates, haptic data, or any other types of wireless communication traffic. Different traffic flows may have different traffic periodicities. In some cases, the different traffic periodicities may be based on different quality of service (QoS) thresholds or latency thresholds for the different types of traffic. For example, a video flow may have a non-integer value periodicity, such as 1000 frames per 60 ms, which may not be supported by NR DRX configurations. In contrast, haptic data, voice data, or control flows may have integer value periodicities, such as 10 ms periodicities. A single DRX cycle or single DRX configuration may fail to support multiple traffic flows with different periodicities which are not multiple integers of each other.

To support multiple traffic flows with different periodicities that are not multiple integers of each other (e.g., non-uniform cycles), a UE 115 may determine on duration start times based on multiple different DRX cycles. Such enhancements for DRX operation may be used to support XR applications or any other applications which have traffic flows with traffic periodicities that are not integer multiples of each other. The UE 115 may support any quantity of DRX cycles concurrently. For example, the UE 115 may start an on duration timer according to start times for one DRX cycle or two or more DRX cycles.

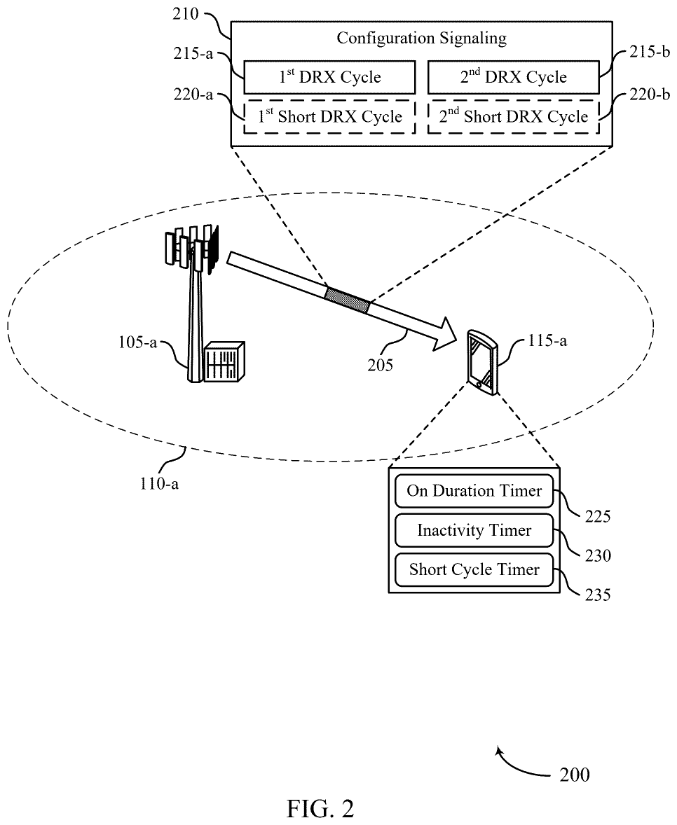

FIG. 2 shows an example of a wireless communications system 200 that supports DRX with non-uniform cycles in accordance with one or more aspects of the present disclosure. The wireless communications system 200 may include a UE 115-a and a network entity 105-a. The network entity 105-a may serve a coverage area 110-a.

The network may configure the UE 115-a with multiple pairs of short and long DRX cycles. Each type of traffic can have its own pair of a short DRX cycle and a long DRX cycle, with a corresponding start offset. In some examples, to reduce processing overhead associated with tracking short versus long cycles, all types of traffic may use the same type of DRX cycle at any time (either all use short DRX cycles or all use long DRX cycles). In some examples, the UE 115-a may use different types of cycles for increased granularity (e.g., at least one short DRX cycle and one long DRX cycle, for example, if a short DRX cycle for one type of traffic is not configured). The configuration of a short DRX cycle for a type of traffic may be optional.

The UE 115-a may reuse DRX timers. For example, the UE 115-a may maintain one on duration timer 225, one inactivity timer 230, and one short cycle timer 235 per MAC entity. In some examples, the on duration timer 225 may be a drx-onDurationTimer. The on duration timer 225 may define a length or duration at the beginning of a DRX cycle. Additionally, or alternatively, the inactivity timer 230 may be a drx-InactivityTimer. The inactivity timer 230 may define a length or duration after a physical downlink control channel (PDCCH) occasion in which a PDCCH indicates a new transmission for the MAC entity. Additionally, or alternatively, the short cycle timer 235 may be a drx-ShortCycleTimer, which may be optional. The short cycle timer 235 may define a length or duration during which the UE 115-a follows one or more short DRX cycles (e.g., configured by the network). If the inactivity timer 230 expires, and if at least one short DRX cycle is configured, the UE 115-a may start or restart the short cycle timer 235. The UE 115-a may use the one or more short DRX cycles while the short cycle timer 235 is active. If the inactivity timer 230 expires and no short DRX cycle is configured, the UE 115-a may use one or more long DRX cycles (e.g., configured by the network). If the short cycle timer 235 expires, the UE 115-a may use the one or more long DRX cycles. If the UE 115-a is in an active time, the UE 115-a may monitor a control channel (e.g., a PDCCH) on one or more serving cells. The active time may include the time while the on duration timer 225 is running, while the inactivity timer 230 is running, or both. In some cases, the active time may include additional time based on other timers, requests, transmissions, or configurations.

The network may configure multiple DRX cycles. The network entity 105-a may transmit configuration signaling 210 via a downlink channel 205. The configuration signaling 210 may be RRC signaling. The configuration signaling 210 may indicate a first DRX cycle 215-a and a second DRX cycle 215-b. The first DRX cycle 215-a and the second DRX cycle 215-b may be long DRX cycles. In some cases, the configuration signaling 210 may indicate any quantity of long DRX cycles. Additionally, or alternatively, the configuration signaling 210 may optionally indicate a first short DRX cycle 220-a, a second short DRX cycle 220-b, or both. In some cases, the configuration signaling 210 may indicate any quantity of short DRX cycles. In some examples, the configuration signaling 210 may indicate the type of traffic corresponding to a configured DRX cycle. In some other examples, the types of traffic corresponding to the DRX cycles may be transparent to the UE 115-a (e.g., the network may track the correspondence between types of traffic and DRX cycles).

The UE 115-a may determine start times for the on duration timer 225 based on the configured DRX cycles. For each type of application configured with its own DRX cycle, the UE 115-a may calculate a set of start times using a formula for DRX on duration timer start times, using the cycle and start offset configured for that type of traffic. For cycles with integer values, the UE 115-a may use a first formula to calculate start times. For cycles with non-integer values, the UE 115-a may use a second formula to calculate start times. For example, the UE 115-a may calculate a first set of on duration timer start times for a first DRX cycle configuration and may calculate a second set of on duration timer start times for a second DRX cycle configuration. If the UE 115-a uses short DRX cycles, a traffic type may be ignored if that traffic type is not configured with a short DRX cycle. The calculated sets of on duration timer start times may be individual on duration timer start time sets (e.g., for individual types of traffic).

The UE 115-a may calculate the actual start times for the on duration timer 225 based on (e.g., by taking) a union of the individual on duration timer start time sets. That is, the UE 115-a may determine the start times for the on duration timer 225 based on the start times for each of the configured DRX cycles (e.g., of a same type, either short or long). In a slot t, if t equals a start time in any of the individual on duration timer start time sets, the UE 115-a may start the on duration timer 225 in the slot t. In some cases, if the on duration timer 225 is already running and an individual on duration timer start time falls within an active time of the already running on duration timer (e.g., while the timer is still running), then the UE 115-a may ignore this individual on duration timer start time. In some other cases, the UE 115-a may restart the on duration timer 225 (e.g., at a maximum duration of the on duration timer or a defined duration) or extend the run time of the on duration timer 225 at this individual on duration timer start time.

The UE 115-a may support DRX inactivity timer management. The UE 115-a may manage the inactivity timer 230 the same or similarly to NR (e.g., legacy) operations. The UE 115-a may start or restart the inactivity timer 230 whenever the UE 115-a receives a downlink control information (DCI) message for a new data transmission (e.g., downlink, uplink, or sidelink). The UE 115-a may start the inactivity timer 230 regardless of which type of application the new data transmission is associated with.

The UE 115-a may switch between short and long DRX cycles. When DRX is initialized, all types of traffic may use short DRX cycles. The UE 115-a may use the short DRX cycles for each traffic type to calculate start times of the on duration timer 225. If a traffic flow is not configured with a short DRX cycle, the UE 115-a may ignore this traffic flow when calculating start times during the short DRX cycle operation. When the short DRX cycle timer expires, the UE 115-a may switch all types of traffic to long DRX cycles. The UE 115-a may use the long DRX cycle of each traffic type to calculate the start times of the on duration timer 225.

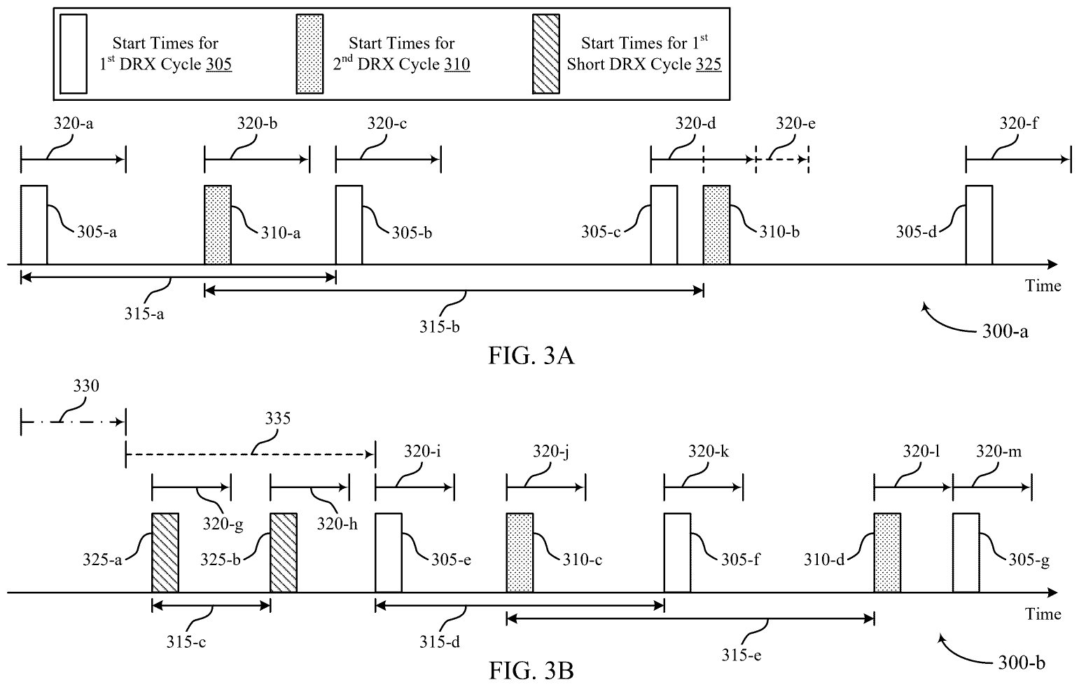

FIGS. 3A and 3B show examples of timelines that support DRX with non-uniform cycles in accordance with one or more aspects of the present disclosure. FIG. 3A shows an example of a timeline 300-a for DRX operation. The timeline 300-a includes a set of start times for starting an on duration timer based on multiple DRX cycles. For example, the set of start times may include start times for a first DRX cycle 305 with a first periodicity 315-a and start times for a second DRX cycle 310 with a second periodicity 315-b. The first periodicity 315-a and the second periodicity 315-b may not be integer multiples of each other, such that the DRX cycles are non-uniform (e.g., non-overlapping or at least partially non-overlapping). A UE 115 may start an on duration timer at the start times, and the on duration timer may run for an on duration timer length. For example, the UE 115 may start the on duration timer at start time 305-a, start time 310-a, start time 305-b, start time 305-c, and start time 305-d. While the on duration timer is running, the UE 115 may monitor a control channel. For example, the UE 115 may monitor the PDCCH for on duration 320-a, on duration 320-b, on duration 320-c, on duration 320-d, and on duration 320-f.

In some cases, a start time 310-b may occur while the on duration timer is still running (e.g., the UE 115 is still active). In some cases, the UE 115 may ignore the start time 310-b based on the on duration timer still running, and the on duration timer may expire after the on duration timer length. In some cases, the UE 115 may restart the on duration timer (e.g., for its on duration timer length) or extend the duration of the on duration timer at the start time 310-b based on the on duration timer still running. For example, the UE 115 may extend the on duration timer by a duration 320-e, and the UE 115 may monitor the PDCCH for on duration 320-e.

FIG. 3B shows another example of a timeline 300-b for DRX operation. The timeline 300-b includes management of multiple timers. For example, a UE 115 may manage an inactivity timer, a short cycle timer, and an on duration timer for a MAC entity. The UE 115 may run the inactivity timer for duration 330 and the short cycle timer for duration 335. The UE 115 may use short DRX cycles while the short cycle timer is running, and may use long DRX cycles when the short cycle timer is not running (e.g., after expiry of the short cycle timer). For example, the UE 115 may start the on duration timer at start time 325-a and start time 325-b based on start times for a first short DRX cycle 325 with a periodicity 315-c while the short cycle timer is active. After expiry of the short cycle timer, the UE 115 may start the on duration timer at start time 305-e, start time 310-c, start time 305-f, start time 310-d, and start time 305-g based on start times for a first DRX cycle 305 (e.g., a first long DRX cycle) with a first periodicity 315-d and start times for a second DRX cycle 310 (e.g., a second long DRX cycle) with a second periodicity 315-e. The UE 115 may monitor the PDCCH for on duration 320-g, on duration 320-h, on duration 320-i, on duration 320-j, on duration 320-k, on duration 320-l, and on duration 320-m.

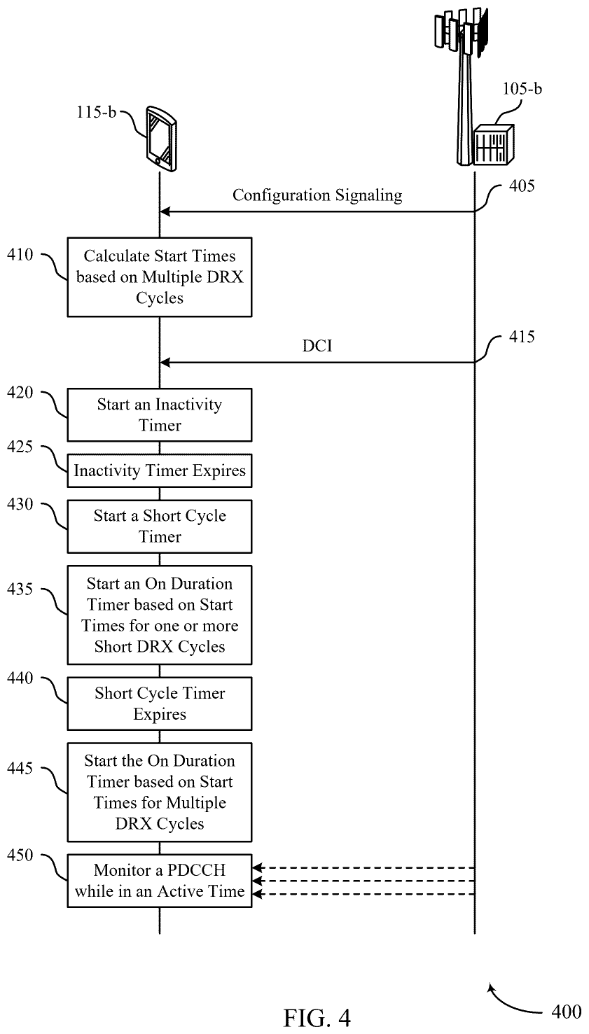

FIG. 4 shows an example of a process flow 400 that supports DRX with non-uniform cycles in accordance with one or more aspects of the present disclosure. A UE 115-b and a network entity 105-b may perform the operations of the process flow 400. For example, at 405, the UE 115-b may receive configuration signaling from the network entity 105-b. The configuration signaling may be RRC signaling (e.g., one or more RRC messages). The configuration signaling may indicate a first value for a first DRX cycle (e.g., a first long DRX cycle) and a second value for a second DRX cycle (e.g., a second long DRX cycle). In some examples, the configuration signaling may additionally indicate a third value for a first short DRX cycle, a fourth value for a second short DRX cycle, or both. The short DRX cycle configurations may be optional.

At 410, the UE 115-b may calculate start times based on multiple DRX cycles. At 415, the UE 115-b may receive a DCI message from the network entity 105-b. At 420, the UE 115-b may start an inactivity timer based on the DCI message. The inactivity timer may expire at 425. At 430, the UE 115-b may start a short cycle timer based on the expiration of the inactivity timer. While the short cycle timer is running, at 435, the UE 115-b may start an on duration timer based on start times for one or more short DRX cycles. The short cycle timer may expire at 440. While the short cycle timer is not running (e.g., after expiration of the short cycle timer), at 445, the UE 115-b may start the on duration timer based on start times for one or more long DRX cycles (e.g., the first DRX cycle and the second DRX cycle). The UE 115-b may monitor for signals while the on duration timer is running. For example, the UE 115-b may monitor a PDCCH at 450 while in an active time, where the active time corresponds to the on duration timer running. The UE 115-b may monitor for multiple types of traffic based on the start times for the on duration timer corresponding to multiple different DRX cycles.

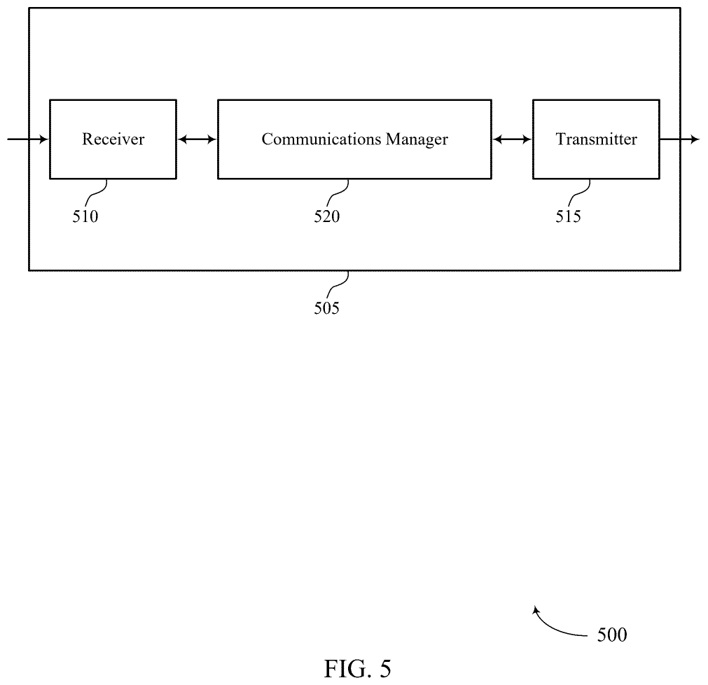

FIG. 5 shows a block diagram 500 of a device 505 that supports DRX with non-uniform cycles in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to DRX with non-uniform cycles). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to DRX with non-uniform cycles). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of DRX with non-uniform cycles as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE, such as a UE 115, in accordance with examples as disclosed herein. For example, the communications manager 520 is capable of, configured to, or operable to support a means for receiving configuration signaling that indicates a first value for a first DRX cycle and a second value for a second DRX cycle. The communications manager 520 is capable of, configured to, or operable to support a means for starting an on duration timer for DRX operation based on a set of multiple start times including both a first set of start times associated with the first value for the first DRX cycle and a second set of start times associated with the second value for the second DRX cycle. The communications manager 520 is capable of, configured to, or operable to support a means for monitoring a PDCCH based on an active time for the UE, where the active time includes a time period when the on duration timer is running.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources. For example, the device 505 may operate using DRX cycles to conserve power by functioning in a relatively low power mode while not in an active time. By determining start times for an on duration timer using multiple DRX cycles, the device 505 may support communications according to multiple traffic types while maintaining support for DRX operations to conserve power. The device 505 may improve communication reliability based on supporting the communications according to multiple traffic types with different communication periodicities.

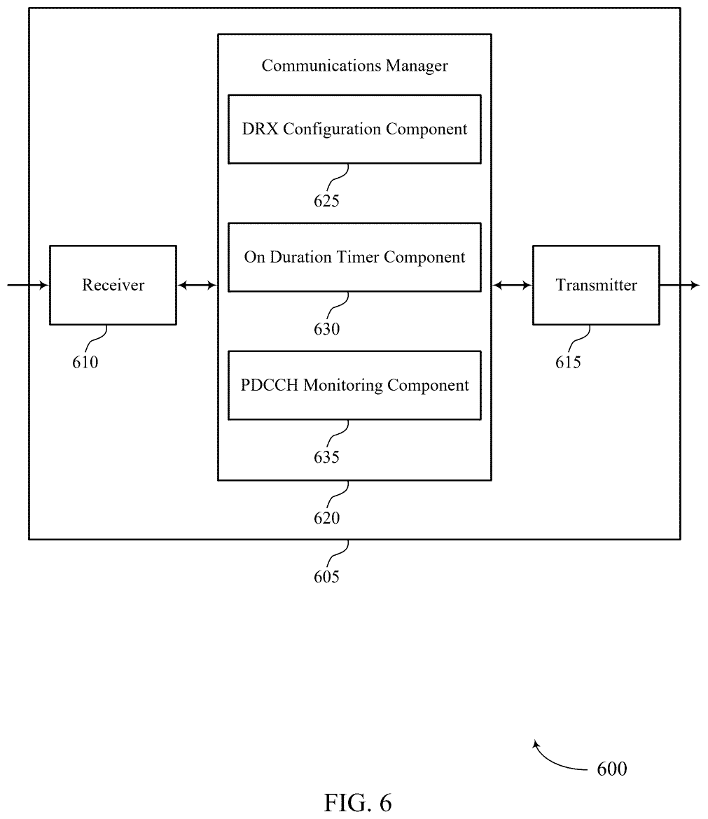

FIG. 6 shows a block diagram 600 of a device 605 that supports DRX with non-uniform cycles in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to DRX with non-uniform cycles). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to DRX with non-uniform cycles). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of DRX with non-uniform cycles as described herein. For example, the communications manager 620 may include a DRX configuration component 625, an on duration timer component 630, a PDCCH monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The DRX configuration component 625 is capable of, configured to, or operable to support a means for receiving configuration signaling that indicates a first value for a first DRX cycle and a second value for a second DRX cycle. The on duration timer component 630 is capable of, configured to, or operable to support a means for starting an on duration timer for DRX operation based on a set of multiple start times including both a first set of start times associated with the first value for the first DRX cycle and a second set of start times associated with the second value for the second DRX cycle. The PDCCH monitoring component 635 is capable of, configured to, or operable to support a means for monitoring a PDCCH based on an active time for the UE, where the active time includes a time period when the on duration timer is running.

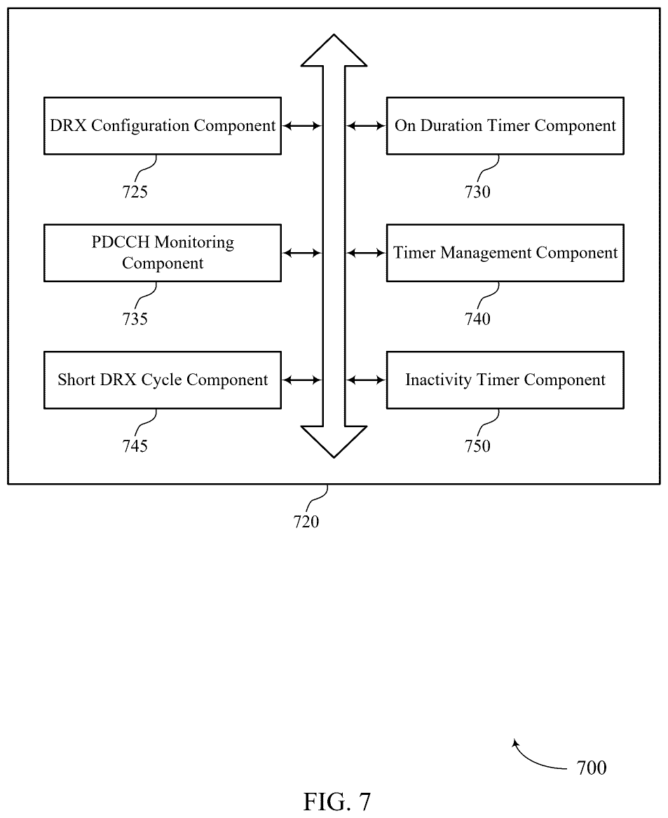

FIG. 7 shows a block diagram 700 of a communications manager 720 that supports DRX with non-uniform cycles in accordance with one or more aspects of the present disclosure. The communications manager 720 may be an example of aspects of a communications manager 520, a communications manager 620, or both, as described herein. The communications manager 720, or various components thereof, may be an example of means for performing various aspects of DRX with non-uniform cycles as described herein. For example, the communications manager 720 may include a DRX configuration component 725, an on duration timer component 730, a PDCCH monitoring component 735, a timer management component 740, a short DRX cycle component 745, an inactivity timer component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications at a UE in accordance with examples as disclosed herein. The DRX configuration component 725 is capable of, configured to, or operable to support a means for receiving configuration signaling that indicates a first value for a first DRX cycle and a second value for a second DRX cycle. The on duration timer component 730 is capable of, configured to, or operable to support a means for starting an on duration timer for DRX operation based on a set of multiple start times including both a first set of start times associated with the first value for the first DRX cycle and a second set of start times associated with the second value for the second DRX cycle. The PDCCH monitoring component 735 is capable of, configured to, or operable to support a means for monitoring a PDCCH based on an active time for the UE, where the active time includes a time period when the on duration timer is running.

In some examples, the on duration timer component 730 is capable of, configured to, or operable to support a means for calculating the set of multiple start times based on a first periodicity corresponding to the first value for the first DRX cycle and a second periodicity corresponding to the second value for the second DRX cycle.

In some examples, the first DRX cycle includes a first long DRX cycle and the second DRX cycle includes a second long DRX cycle. In some examples, the set of multiple start times includes a first set of multiple start times associated with a long DRX cycle. In some examples, the configuration signaling further indicates a third value for a first short DRX cycle, a fourth value for a second short DRX cycle, or both.

In some examples, the short DRX cycle component 745 is capable of, configured to, or operable to support a means for starting a short cycle timer for the DRX operation. In some examples, the on duration timer component 730 is capable of, configured to, or operable to support a means for starting the on duration timer based on a second set of multiple start times associated with the third value for the first short DRX cycle, the fourth value for the second short DRX cycle, or both in accordance with the short cycle timer running, where the on duration timer is started based on the first set of multiple start times associated with the long DRX cycle in accordance with an expiration of the short cycle timer. In some examples, the inactivity timer component 750 is capable of, configured to, or operable to support a means for starting an inactivity timer for the DRX operation, where the short cycle timer is started or restarted in accordance with an expiration of the inactivity timer. In some examples, the first long DRX cycle and the first short DRX cycle correspond to a first type of traffic. In some examples, the second long DRX cycle and the second short DRX cycle correspond to a second type of traffic different from the first type of traffic.

In some examples, the first DRX cycle corresponds to a first type of traffic and the second DRX cycle corresponds to a second type of traffic different from the first type of traffic.

In some examples, the on duration timer component 730 is capable of, configured to, or operable to support a means for refraining from starting or restarting the on duration timer based on a start time of the set of multiple start times occurring when the on duration timer is running. In some other examples, the on duration timer component 730 is capable of, configured to, or operable to support a means for restarting the on duration timer based on a start time of the set of multiple start times occurring when the on duration timer is running.

In some examples, the timer management component 740 is capable of, configured to, or operable to support a means for maintaining the on duration timer, an inactivity timer, and a short cycle timer for a MAC entity.

In some examples, the first value, the second value, or both are integer values, non-integer values, or a combination thereof. In some examples, the on duration timer is a drx-onDurationTimer. In some examples, the configuration signaling includes an RRC message.

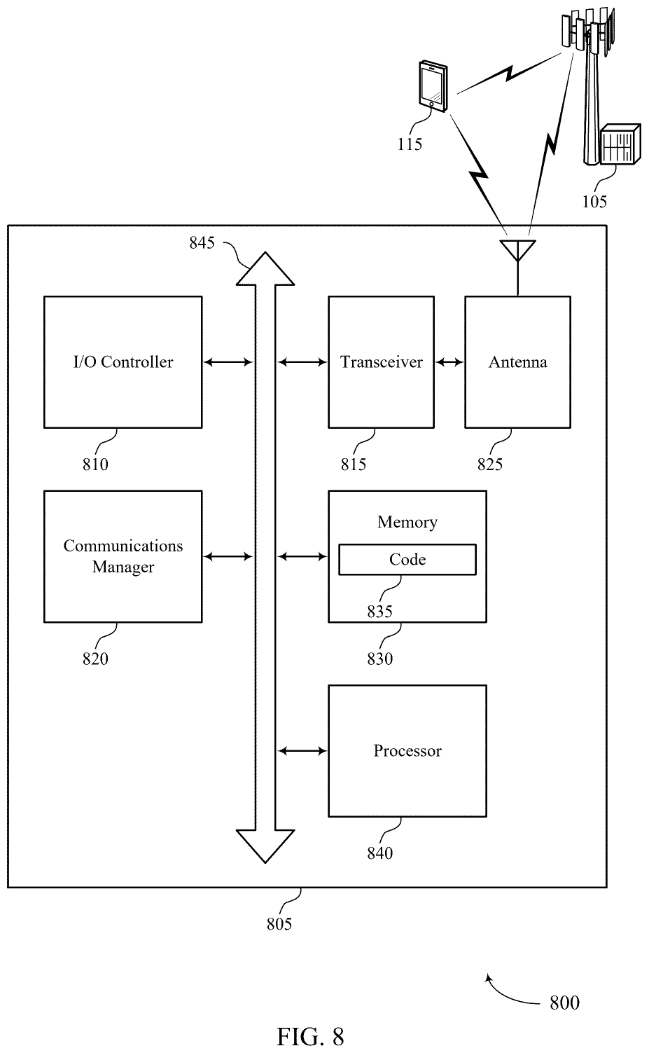

FIG. 8 shows a diagram of a system 800 including a device 805 that supports DRX with non-uniform cycles in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting DRX with non-uniform cycles). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration signaling that indicates a first value for a first DRX cycle and a second value for a second DRX cycle. The communications manager 820 is capable of, configured to, or operable to support a means for starting an on duration timer for DRX operation based on a set of multiple start times including both a first set of start times associated with the first value for the first DRX cycle and a second set of start times associated with the second value for the second DRX cycle. The communications manager 820 is capable of, configured to, or operable to support a means for monitoring a PDCCH based on an active time for the UE, where the active time includes a time period when the on duration timer is running.

By including or configuring the communications manager 820 in accordance with examples as described herein, the device 805 may support techniques for improved communication reliability (e.g., for different types of traffic associated with different communication periodicities), reduced power consumption, more efficient utilization of communication resources, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of DRX with non-uniform cycles as described herein, or the at least one processor 840 and the at least one memory 830 may be otherwise configured to, individually or collectively, perform or support such operations.

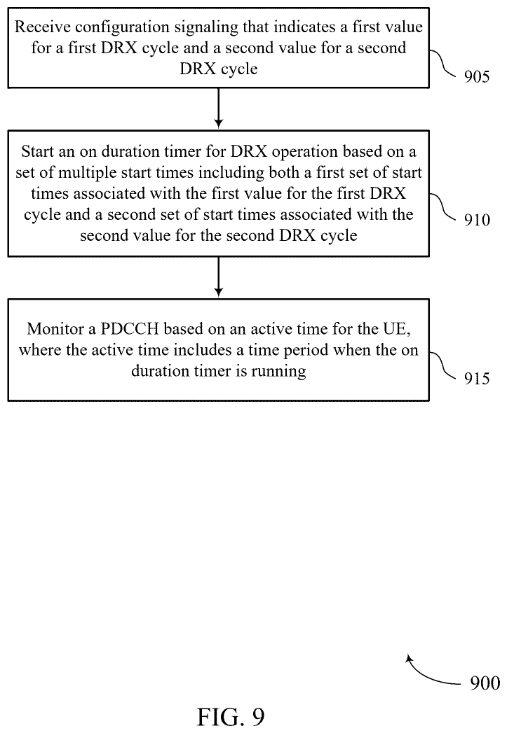

FIG. 9 shows a flowchart illustrating a method 900 that supports DRX with non-uniform cycles in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.
At 905, the method may include receiving configuration signaling that indicates a first value for a first DRX cycle and a second value for a second DRX cycle. The operations of 905 may be performed in accordance with examples as disclosed herein. In some examples, aspects of the operations of 905 may be performed by a DRX configuration component 725 as described with reference to FIG. 7.
At 910, the method may include starting an on duration timer for DRX operation based on a set of multiple start times. The set of multiple start times may include both a first set of start times associated with the first value for the first DRX cycle and a second set of start times associated with the second value for the second DRX cycle. The operations of 910 may be performed in accordance with examples as disclosed herein. In some examples, aspects of the operations of 910 may be performed by an on duration timer component 730 as described with reference to FIG. 7.
At 915, the method may include monitoring a PDCCH based on an active time for the UE. The active time may include a time period when the on duration timer is running. The operations of 915 may be performed in accordance with examples as disclosed herein. In some examples, aspects of the operations of 915 may be performed by a PDCCH monitoring component 735 as described with reference to FIG. 7.

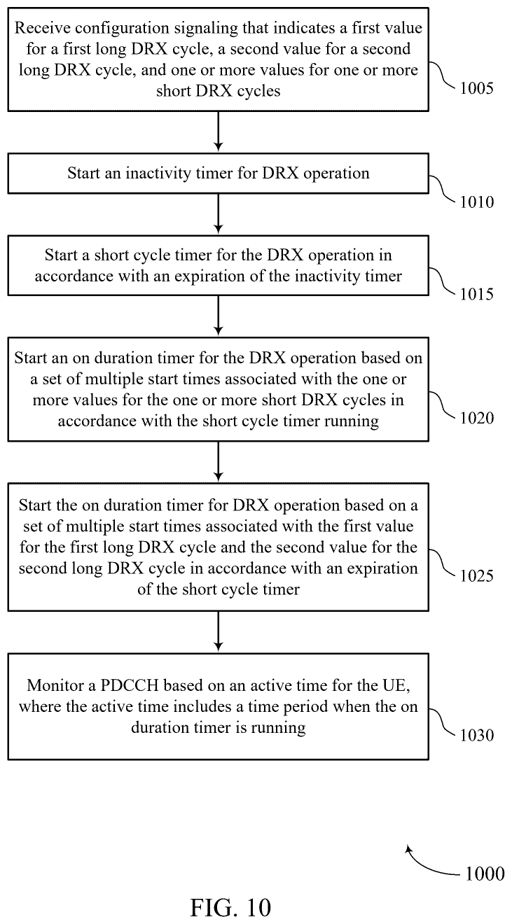

FIG. 10 shows a flowchart illustrating a method 1000 that supports DRX with non-uniform cycles in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.
At 1005, the method may include receiving configuration signaling that indicates a first value for a first long DRX cycle, a second value for a second long DRX cycle, and one or more values for one or more short DRX cycles. The operations of 1005 may be performed in accordance with examples as disclosed herein. In some examples, aspects of the operations of 1005 may be performed by a DRX configuration component 725 as described with reference to FIG. 7.
At 1010, the method may include starting an inactivity timer for DRX operation. The operations of 1010 may be performed in accordance with examples as disclosed herein. In some examples, aspects of the operations of 1010 may be performed by an inactivity timer component 750 as described with reference to FIG. 7.
At 1015, the method may include starting or restarting a short cycle timer for the DRX operation in accordance with an expiration of the inactivity timer. The operations of 1015 may be performed in accordance with examples as disclosed herein. In some examples, aspects of the operations of 1015 may be performed by a short DRX cycle component 745 as described with reference to FIG. 7.
At 1020, the method may include starting an on duration timer for the DRX operation based on a set of multiple start times associated with the one or more values for the one or more short DRX cycles in accordance with the short cycle timer running. The operations of 1020 may be performed in accordance with examples as disclosed herein. In some examples, aspects of the operations of 1020 may be performed by an on duration timer component 730 as described with reference to FIG. 7.
At 1025, the method may include starting the on duration timer for the DRX operation based on a set of multiple start times including both a first set of start times associated with the first value for the first long DRX cycle and a second set of start times associated with the second value for the second long DRX cycle in accordance with an expiration of the short cycle timer. The operations of 1025 may be performed in accordance with examples as disclosed herein. In some examples, aspects of the operations of 1025 may be performed by an on duration timer component 730 as described with reference to FIG. 7.
At 1030, the method may include monitoring a PDCCH based on an active time for the UE, where the active time includes a time period when the on duration timer is running. The operations of 1030 may be performed in accordance with examples as disclosed herein. In some examples, aspects of the operations of 1030 may be performed by a PDCCH monitoring component 735 as described with reference to FIG. 7.

The following provides an overview of aspects of the present disclosure:

Aspect 1: A method for wireless communications at a UE, comprising: receiving configuration signaling that indicates a first value for a first DRX cycle and a second value for a second DRX cycle; starting an on duration timer for DRX operation based at least in part on a plurality of start times comprising both a first set of start times associated with the first value for the first DRX cycle and a second set of start times associated with the second value for the second DRX cycle; and monitoring a PDCCH based at least in part on an active time for the UE, wherein the active time comprises a time period when the on duration timer is running.

Aspect 2: The method of aspect 1, further comprising: calculating the plurality of start times based at least in part on a first periodicity corresponding to the first value for the first DRX cycle and a second periodicity corresponding to the second value for the second DRX cycle.

Aspect 3: The method of either of aspects 1 or 2, wherein: the first DRX cycle comprises a first long DRX cycle and the second DRX cycle comprises a second long DRX cycle; the plurality of start times comprises a first plurality of start times associated with a long DRX cycle; and the configuration signaling further indicates a third value for a first short DRX cycle, a fourth value for a second short DRX cycle, or both.

Aspect 4: The method of aspect 3, further comprising: starting a short cycle timer for the DRX operation; and starting the on duration timer based at least in part on a second plurality of start times associated with the third value for the first short DRX cycle, the fourth value for the second short DRX cycle, or both in accordance with the short cycle timer running, wherein the on duration timer is started based at least in part on the first plurality of start times associated with the long DRX cycle in accordance with an expiration of the short cycle timer.

Aspect 5: The method of aspect 4, further comprising: starting an inactivity timer for the DRX operation, wherein the short cycle timer is started or restarted in accordance with an expiration of the inactivity timer.

Aspect 6: The method of any of aspects 3 through 5, wherein the first long DRX cycle and the first short DRX cycle correspond to a first type of traffic; and the second long DRX cycle and the second short DRX cycle correspond to a second type of traffic different from the first type of traffic.

Aspect 7: The method of any of aspects 1 through 6, wherein the first DRX cycle corresponds to a first type of traffic and the second DRX cycle corresponds to a second type of traffic different from the first type of traffic.

Aspect 8: The method of any of aspects 1 through 7, further comprising: refraining from starting or restarting the on duration timer based at least in part on a start time of the plurality of start times occurring when the on duration timer is running.

Aspect 9: The method of any of aspects 1 through 8, further comprising: restarting the on duration timer based at least in part on a start time of the plurality of start times occurring when the on duration timer is running.

Aspect 10: The method of any of aspects 1 through 9, further comprising: maintaining the on duration timer, an inactivity timer, and a short cycle timer for a MAC entity.

Aspect 11: The method of any of aspects 1 through 10, wherein the first value, the second value, or both are integer values, non-integer values, or a combination thereof.

Aspect 12: The method of any of aspects 1 through 11, wherein the on duration timer is a drx-onDurationTimer.

Aspect 13: The method of any of aspects 1 through 12, wherein the configuration signaling comprises an RRC message.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration signaling that indicates a first value for a first discontinuous reception cycle and a second value for a second discontinuous reception cycle;
start an on duration timer for discontinuous reception operation based at least in part on a plurality of start times comprising both a first set of start times associated with the first value for the first discontinuous reception cycle and a second set of start times associated with the second value for the second discontinuous reception cycle; and
monitor a physical downlink control channel based at least in part on an active time for the UE,
wherein the active time comprises a time period when the on duration timer is running.

2. The UE of claim 1, wherein the one or more processors are individually or collectively further operable to execute the code to cause the UE to:
calculate the plurality of start times based at least in part on a first periodicity corresponding to the first value for the first discontinuous reception cycle and a second periodicity corresponding to the second value for the second discontinuous reception cycle.

3. The UE of claim 1, wherein:
the first discontinuous reception cycle comprises a first long discontinuous reception cycle and the second discontinuous reception cycle comprises a second long discontinuous reception cycle;
the plurality of start times comprises a first plurality of start times associated with a long discontinuous reception cycle; and
the configuration signaling further indicates a third value for a first short discontinuous reception cycle, a fourth value for a second short discontinuous reception cycle, or both.

4. The UE of claim 3, wherein the one or more processors are individually or collectively further operable to execute the code to cause the UE to:
start a short cycle timer for the discontinuous reception operation; and
start the on duration timer based at least in part on a second plurality of start times associated with the third value for the first short discontinuous reception cycle, the fourth value for the second short discontinuous reception cycle, or both in accordance with the short cycle timer running,
wherein the on duration timer is started based at least in part on the first plurality of start times associated with the long discontinuous reception cycle in accordance with an expiration of the short cycle timer.

5. The UE of claim 4, wherein the one or more processors are individually or collectively further operable to execute the code to cause the UE to:
start an inactivity timer for the discontinuous reception operation,
wherein the short cycle timer is started or restarted in accordance with an expiration of the inactivity timer.

6. The UE of claim 3, wherein:
the first long discontinuous reception cycle and the first short discontinuous reception cycle correspond to a first type of traffic; and
the second long discontinuous reception cycle and the second short discontinuous reception cycle correspond to a second type of traffic different from the first type of traffic.

7. The UE of claim 1, wherein:
the first discontinuous reception cycle corresponds to a first type of traffic and the second discontinuous reception cycle corresponds to a second type of traffic different from the first type of traffic.

8. The UE of claim 1, wherein the one or more processors are individually or collectively further operable to execute the code to cause the UE to:
refrain from starting or restarting the on duration timer based at least in part on a start time of the plurality of start times occurring when the on duration timer is running.

9. The UE of claim 1, wherein the one or more processors are individually or collectively further operable to execute the code to cause the UE to:
restart the on duration timer based at least in part on a start time of the plurality of start times occurring when the on duration timer is running.

10. The UE of claim 1, wherein the one or more processors are individually or collectively further operable to execute the code to cause the UE to:
maintain the on duration timer, an inactivity timer, and a short cycle timer for a medium access control entity.

11. The UE of claim 1, wherein:
the first value, the second value, or both are integer values, non-integer values, or a combination thereof.

12. The UE of claim 1, wherein:
the on duration timer is a drx-onDurationTimer.

13. The UE of claim 1, wherein:
the configuration signaling comprises a radio resource control message.

14. A method for wireless communications at a user equipment (UE), comprising:
receiving configuration signaling that indicates a first value for a first discontinuous reception cycle and a second value for a second discontinuous reception cycle;
starting an on duration timer for discontinuous reception operation based at least in part on a plurality of start times comprising both a first set of start times associated with the first value for the first discontinuous reception cycle and a second set of start times associated with the second value for the second discontinuous reception cycle; and
monitoring a physical downlink control channel based at least in part on an active time for the UE,
wherein the active time comprises a time period when the on duration timer is running.

15. The method of claim 14, further comprising:
calculating the plurality of start times based at least in part on a first periodicity corresponding to the first value for the first discontinuous reception cycle and a second periodicity corresponding to the second value for the second discontinuous reception cycle.

16. The method of claim 14, wherein:
the first discontinuous reception cycle comprises a first long discontinuous reception cycle and the second discontinuous reception cycle comprises a second long discontinuous reception cycle;
the plurality of start times comprises a first plurality of start times associated with a long discontinuous reception cycle; and
the configuration signaling further indicates a third value for a first short discontinuous reception cycle, a fourth value for a second short discontinuous reception cycle, or both.

17. The method of claim 16, further comprising:
starting a short cycle timer for the discontinuous reception operation; and
starting the on duration timer based at least in part on a second plurality of start times associated with the third value for the first short discontinuous reception cycle, the fourth value for the second short discontinuous reception cycle, or both in accordance with the short cycle timer running,
wherein the on duration timer is started based at least in part on the first plurality of start times associated with the long discontinuous reception cycle in accordance with an expiration of the short cycle timer.

18. The method of claim 17, further comprising:
starting an inactivity timer for the discontinuous reception operation,
wherein the short cycle timer is started or restarted in accordance with an expiration of the inactivity timer.

19. The method of claim 16, wherein:
the first long discontinuous reception cycle and the first short discontinuous reception cycle correspond to a first type of traffic; and
the second long discontinuous reception cycle and the second short discontinuous reception cycle correspond to a second type of traffic different from the first type of traffic.

20. A non-transitory computer-readable medium at a user equipment (UE) storing code for wireless communications, the code comprising instructions executable by one or more processors to:
receive configuration signaling that indicates a first value for a first discontinuous reception cycle and a second value for a second discontinuous reception cycle;
start an on duration timer for discontinuous reception operation based at least in part on a plurality of start times comprising both a first set of start times associated with the first value for the first discontinuous reception cycle and a second set of start times associated with the second value for the second discontinuous reception cycle; and
monitor a physical downlink control channel based at least in part on an active time for the UE,
wherein the active time comprises a time period when the on duration timer is running.
